(19) United States
(12) Patent Application Publication
(10) Pub. No.: US 2017/0039676 A1
(43) Pub. Date: Feb. 9, 2017

(54) GRAPHICS SYSTEM AND ASSOCIATED METHOD FOR GENERATING DIRTINESS INFORMATION IN IMAGE HAVING MULTIPLE FRAMES

(71) Applicant: MEDIATEK INC., Hsin-Chu (TW)

(72) Inventors: Chiung-Fu CHEN, Hsinchu City (TW); Jia-Hsiung HUANG, Taipei City (TW)

(21) Appl. No.: 15/334,258

(22) Filed: Oct. 25, 2016

Related U.S. Application Data
(63) Continuation-in-part of application No. 15/137,418, filed on Apr. 25, 2016.
(60) Provisional application No. 62/157,066, filed on May 5, 2015.

(51) Int. Cl. G06T 1/60; G06T 1/20

(52) U.S. Cl. CPC G06T 1/60; G06T 1/20; G06T 2207/20021

(57) ABSTRACT

A graphics system and an associated method for generating dirtiness information indicating dirty regions between frames of image data in a graphics system are provided. The method includes the steps of: dividing each of the frames of the image data into a plurality of regions; obtaining a respective checksum for each region of the frames; and generating the dirtiness information of each frame of the image data according to the respective checksum of each region of the current frame and the previous frame.

### CROSS REFERENCE TO RELATED APPLICATIONS

This application is a Continuation-In-Part of application Ser. No. 15/137,418, filed on Apr. 25, 2016, which claims the benefit of provisional Application No. 62/157,066, filed on May 5, 2015.

### BACKGROUND OF THE INVENTION

### Field of the Invention

The invention relates to graphics processing, and, in particular, to a graphics system and a method for generating dirtiness information to indicate a damaged region between the frames of image data in a graphics system.

### Description of the Related Art

Mobile devices on the market are usually equipped with graphics systems such as a graphics processing unit for rendering and composing image data with multiple frames. Conventionally, the graphics system also includes a compositor to generate a resulting image according to the frames of the image data.

Conventionally, the graphics system also performs a dirty region calculation to identify dirty regions, which describe screen regions been changed, to track screen updates. However, the dirty region calculation in a conventional graphics system is not precise enough, so the compositor may waste time recomposing unnecessary regions even if only parts of the regions have been changed. For example, in cases where video data is being played on a webpage, only the frames of the video data are changed. The dirty regions, however, may be identified as all regions of whole webpage rather than just the regions of the video data. In such cases, the compositor needs to retrieve all pixels of the dirty regions of the frames from the frame buffer when generating a resulting image and thus the time that it takes to recompose regions other than the regions of the video data is wasted.

Accordingly, there is demand for a graphics system and an associated method for precisely identifying dirty regions between frames of image data to solve the aforementioned problem.

### BRIEF SUMMARY OF THE INVENTION

A detailed description is given in the following embodiments with reference to the accompanying drawings.

In an exemplary embodiment, a method for generating dirtiness information indicating dirty regions between frames of image data in a graphics system is provided. The method includes the steps of: dividing each of the frames of the image data into a plurality of regions; obtaining a respective checksum of each region in the frames; and generating dirtiness information for each frame of the image data according to the respective checksum of each region of a current frame and a previous frame.

In another exemplary embodiment, a graphics system is provided. The graphics system includes a graphics processing unit (GPU) and a dirtiness information generator. The graphics processing unit (GPU) is configured to divide each of the frames into a plurality of regions. The dirtiness information generator is configured to obtain the checksum of each region of the frames, and generate the dirtiness information of each frame of the image data according to the respective checksum of each region of a current frame and a previous frame.

Other aspects and features of the present invention will become apparent to those with ordinary skill in the art upon review of the following descriptions of specific embodiments of the graphics systems for carrying out the methods for generating dirtiness information in images having multiple frames.

### BRIEF DESCRIPTION OF THE DRAWINGS

The invention can be more fully understood by reading the subsequent detailed description and examples with references made to the accompanying drawings, wherein:

FIG. 1 is a diagram of a graphics system in accordance with an embodiment of the invention;

FIG. 2A is a diagram illustrating an image composed of the frames and respective checksums in accordance with an embodiment of the invention;

FIG. 2B is a diagram of a content update in the frames of FIG. 2A in accordance with the embodiment of the invention;

FIG. 2C is a diagram of the dirty regions of each frame according to the content update in the frames of FIG. 2B in accordance with the embodiment of the invention;

FIG. 3 is a flow chart of a method for generating dirtiness information for image data composed of a plurality of frames in a graphics system in accordance with an embodiment of the invention; and

FIG. 4 is a flow chart of a method for generating dirtiness information for image data composed of a plurality of frames in a graphics system in accordance with another embodiment of the invention.

### DETAILED DESCRIPTION OF THE INVENTION

This description is made for the purpose of illustrating the general principles of the invention and should not be taken in a limiting sense. The scope of the invention is best determined by reference to the appended claims. It should be understood that the embodiments may be realized in software, hardware, firmware, or any combination thereof.

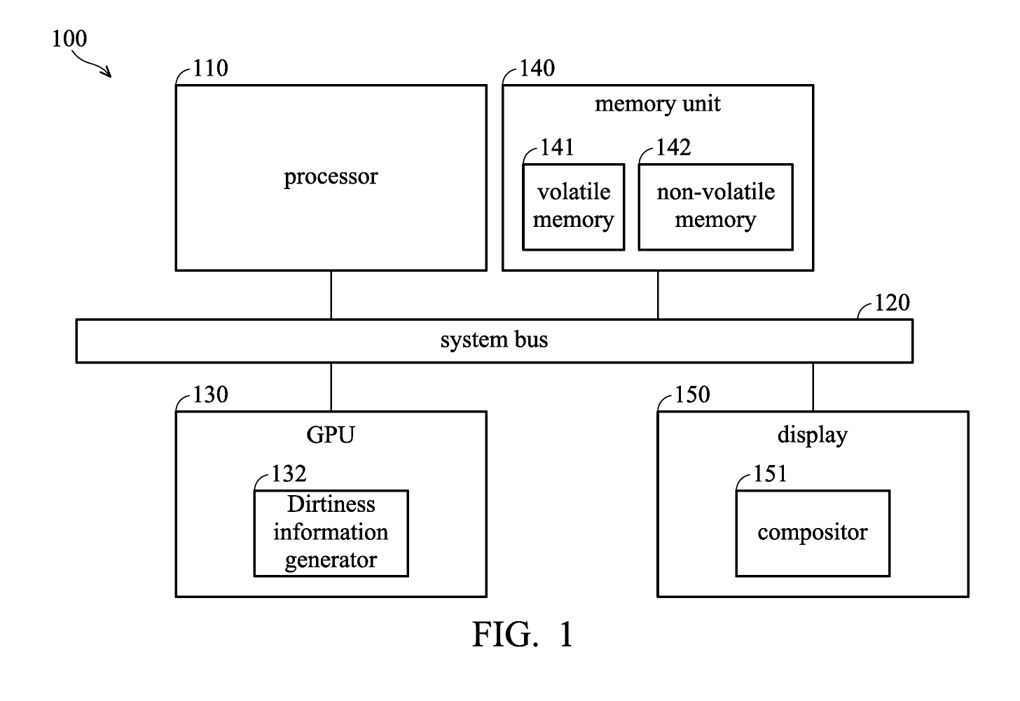

FIG. 1 is a diagram of a graphics system in accordance with an embodiment of the invention. The graphics system 100 can be a mobile device (e.g., a tablet computer, a smartphone, or a wearable computing device) or a laptop computer capable of acquiring images. The graphics system 100 can also be implemented as multiple chips or a single ship such as a system on chip (SOC) or a mobile processor disposed in a mobile device. For example, the graphics system 100 comprises a processor 110, a system bus 120, a graphics processing unit (GPU) 130, a memory unit 140, and a display 150. The processor 110, the GPU 130, and the memory unit 140 can be coupled to each other through the system bus 120. The processor 110 may be a central processing unit (CPU) general-purpose processor, a digital signal processor (DSP), or any equivalent circuitry, but the disclosure is not limited thereto. The memory unit 140, for example, may include a volatile memory 141 and a non-volatile memory 142. The volatile memory 141 may be a dynamic random access memory (DRAM) or a static random access memory (SRAM), and the non-volatile memory 142 may be a flash memory, a hard disk, a solid-state disk (SSD), etc. For example, the program codes of the applications for use on the graphics system 100 can be pre-stored in the non-volatile memory 142. The processor 110 may load program codes of the applications from the non-volatile memory 142 to the volatile memory 141, and execute the program code of the applications. The processor 110 may also transmit the graphics data to the GPU 130, and the GPU 130 may determine the graphics data to be rendered on the display 150 (the details will be described later). It should be noted that although the volatile memory 141 and the non-volatile memory 142 are illustrated as a memory unit, they can be implemented separately as different memory units. In addition, a different number of volatile memory 141 and/or non-volatile memory 142 units can also be implemented in different embodiments. The display 150 can be a display circuit or hardware that can be coupled for controlling a display device (not shown). The display device may include either or both of a driving circuit and a display panel and can be disposed internal or external to the graphics system 100.

In an embodiment, the GPU 130 may comprise a dirtiness information generator 132. In some other embodiments, the dirtiness information generator 132 is a stand-alone circuit that is external to the GPU 130. The dirtiness information generator 132 can be configured to generate dirtiness information according to the graphics data such as image data with a plurality of frames. For example, each of the frames of the image data is divided into a plurality of regions, and each region has a respective checksum (e.g. a hash value or a CRC value) that is determined by either the processor 110 or the GPU 130 or both. The divided regions can be equally-sized tiles or blocks or non-equally-sized tiles or blocks. Each frame can be divided in the same way. In addition, the frames to be rendered can be stored in the memory unit 140, e.g., in the volatile memory 141. The dirtiness information generator 132 may obtain the respective checksum of each region of the frames from the volatile memory 141, and generate dirtiness information for each region of the frames according to the checksums of regions of the frames. In one embodiment, each frame and its respective checksums can be stored in the same frame buffer. In another embodiment, each frame and its respective checksums can be stored in different frame buffer. For example, the frame can be stored in a first frame buffer, and the respective checksums can be stored in a second frame buffer.

In an embodiment, the display 150 may comprise a compositor 151. In some other embodiments, the compositor 151 is a stand-alone circuit that is external to the display 150. The compositor 151 can be configured to generate a resulting blended image or a frame according to the graphics data such as a plurality of frames or overlay image layers. The compositor 151 may obtain the respective dirtiness information of each region of the frames from the volatile memory 141, and generate a blended image according to the dirtiness information of each region of the frames.

In an embodiment, each of the frames is divided into a plurality of regions, and each region of the frame also includes a plurality of pixels. The respective pixel data that is associated with each pixel of the frames can be stored in one or more frame buffers of the graphics system. In some embodiments, each region in the frames has its own checksums, and the respective checksums associated with each region of the frames can be determined according to the pixel data associated with the pixels of the region of the frames by using a checksum algorithm such as cyclic redundancy checks (CRC), Fletcher's checksum, Adler-32 and so on. For example, in one embodiment, the checksum is a CRC (e.g., a 16-bit or 32-bit CRC) and the checksum of a specific region of a current frame can be determined by applying a CRC checking algorithm to the pixel data associated with the pixels of the specific region of the current frame. In another embodiment, the checksum of the specific region of the current frame can be the output of a hash function applied to the pixel data associated with the pixels of the specific region in the specific region. Generally, regions with the same checksum are identical.

It should be noted that a detailed description of checksum algorithms and checksum generation is omitted herein for brevity since it is beyond the scope of the application, and reference may be made to any checksum algorithm well-known by those who are skilled in this technology.

The dirtiness information generator 132 makes a determination as to whether each region has undergone a change between the current frame and a previous frame based on the respective checksums. It should be understood that, the frames are sequentially displayed according to a display order and the current frame is to be displayed next to the previous frame. That is, the previous frame comes before the current frame. If a region has changed (i.e., the display content of the region in the current frame is different from the display content of the region in the previous frame), then the dirtiness information generator 132 indicates that the region is a dirty region. If the region hasn't changed (i.e., the display content of the region in the current frame is the same as the display content of the region in the previous frame), then the dirtiness information generator 132 indicates that it is a non-dirty region. For comparing a region in the current frame with its corresponding region in the previous frame, the dirtiness information generator 132 only compares the checksums (e.g., CRC values or hash values) of the regions being compared to determine if a region has changed. For subsequent frames, the stored checksum of each region is compared against the checksum of the corresponding region and if they match each other, the dirtiness information generator 132 may generate corresponding dirtiness information indicating that the region being compared is a non-dirty region.

When the pixel values associated with a certain region in a current frame are different from the pixel values associated with the same region in a previous frame (frame at an earlier time) (e.g., the certain region in the current frame has changed from what it was in that previous frame), the checksum of the certain region in the current frame is different from the checksum of the certain region in the previous frame so that the dirtiness information associated with the certain region in the current frame indicates that the pixels in the certain region are dirty. Accordingly, the pixel values associated with the certain region in the current frame are required to be retrieved to update the display 150. In contrast, when the pixel values associated with the certain region in the certain frame are the same as the pixel values associated with the same region in a previous frame, the checksum of the certain region in the current frame is the same as the checksum of the certain region in the previous frame so that the dirtiness information associated with the certain region in the current frame indicates that the pixels in the certain region are non-dirty. Accordingly, for display 150, it is not necessary to retrieve the pixel values associated with the certain region in the current frame, and it can be skipped.

The compositor 151 may then obtain the respective dirtiness information of each region of the frames from the volatile memory 141, and generate a blended image according to the dirtiness information of each region of the frames.

It should be noted that the compositor 151 may determine whether to retrieve or skip pixel data of each region of the frames from the respective frame buffers according to the retrieved dirtiness information associated with each region of the frames. In an embodiment where the respective dirtiness information of a specific region of the frame indicates a non-dirty region, the compositor 151 may skip data access of the specific region in the frames. In contrast, when the dirtiness information of a specific region in the frames indicates a dirty region, the compositor 151 may retrieve data of the specific region in the frames.

When the dirtiness information of any region of any frame in the frames indicates a non-dirty region, the compositor can skip retrieving pixel values of the non-dirty region of the frame. Specifically, when the dirtiness information associated with a certain region of a current frame indicates that the pixels in the region are dirty, it indicates that the pixel values associated with the certain region in the current frame are different from the pixel values associated with the same region in a previous frame. Accordingly, the pixel values associated with the certain region for the certain frame are required to be retrieved to update the display 150. In contrast, when the dirtiness information associated with a certain region of a current frame indicates that the pixels in the region are non-dirty, it indicates that the pixel values associated with the certain region in the certain frame are the same as the pixel values associated with the same region in a previous frame. Accordingly, it is not necessary to retrieve the pixel values associated with the certain region in the current frame, and it can be skipped.

In addition, the checksums associated with all of the regions in the frames can be stored in one or more frame buffers of the graphics system 100. For example, the volatile memory 141 may include a plurality of partitions, and each partition can be regarded as a frame buffer, and the respective checksums associated with each region of the frames can be stored in one or more frame buffers of the graphics system 100. The frame buffers storing the checksum of each region of the frames can be the same as those storing the pixel data of each region of the frames. Alternatively, the frame buffers storing the checksum of each region of the frames can also be different from those storing the pixel data of each region of the frames.

It should be understood that the components described in the embodiment of FIG. 1 are for illustrative purposes only and are not intended to limit the scope of the application.

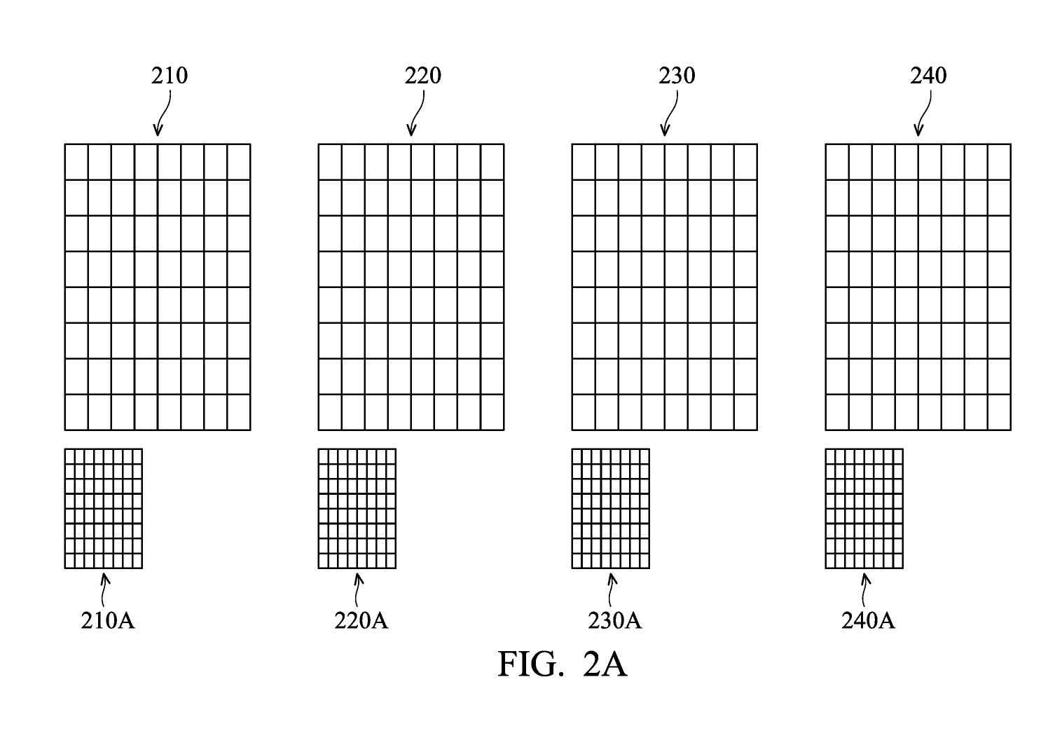

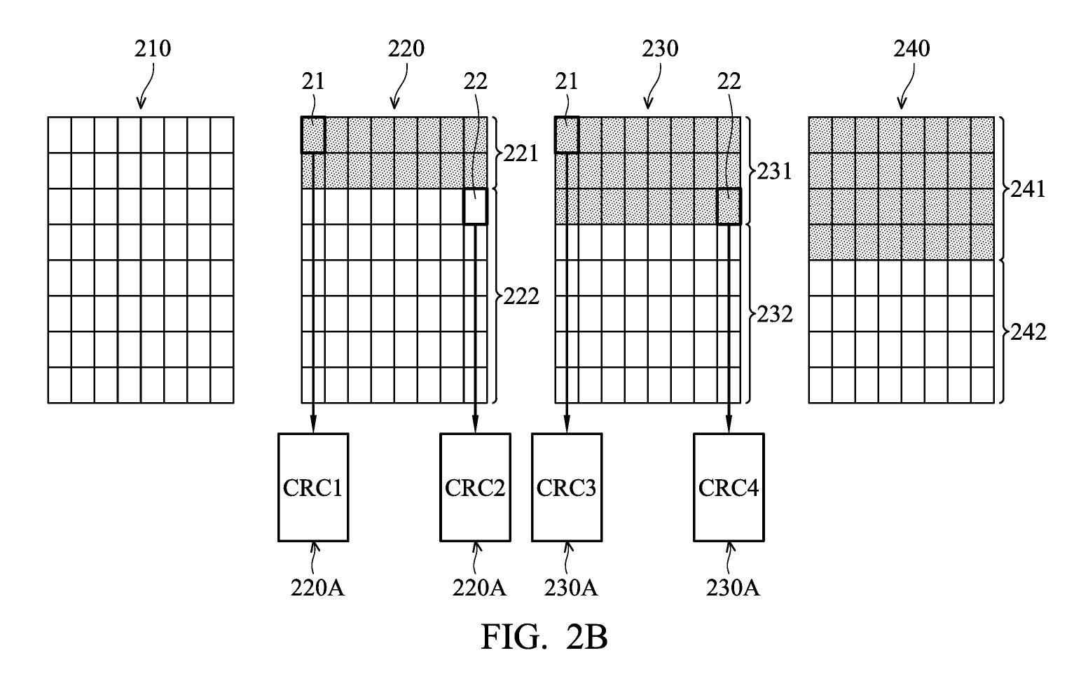

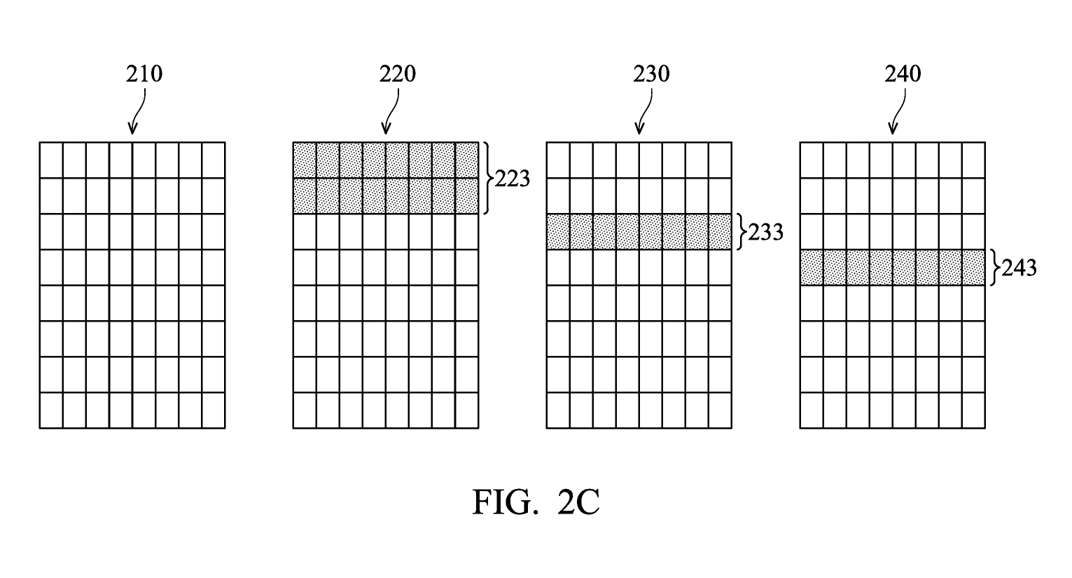

FIG. 2A is a diagram of the frame images and respective checksums in accordance with an embodiment of the invention. For example, there are 4 frame images such as frame 210, frame 220, frame 230 and frame 240. Frame 210, frame 220, frame 230 and frame 240 are sequentially rendered by the GPU 130. To be more specific, in FIG. 2A, frame 210 is the previous frame for frame 220. Similarly, frame 220 is the previous frame for frame 230 and frame 230 is the previous frame for frame 240. Frame 210 and 230 can be stored in the same frame buffer of the volatile memory 141 (i.e. a first frame buffer) as well as their respective checksums 210A and 230A of each region for example. Similarly, the frames 220 and 240 can be stored in another frame buffer of the volatile memory 141 (i.e. a second frame buffer) as well as their respective checksums 220A and 240A of the regions for example. Specifically, the checksum of each region in frame 210 is recorded as data 210A. Similarly, the checksums of each region in the frames 220, 230 and 240 are recorded as data 220A, 230A and 240A, as shown in FIG. 2. For the purposes of description, the number of frames is 4 and the number of frame buffers is 2 in the aforementioned embodiment. One having ordinary skill in the art will appreciate that a different number of frames and a different number of frame buffers can be used. The actual number of frames and frames buffers may vary.

FIG. 2B is a diagram of a content update in the frames of FIG. 2A in accordance with the embodiment of the invention. As shown in FIG. 2B, different contents to be displayed on the screen are varied from the frames 210 to 240 respectively, wherein a marked area in the frame represents contents to be displayed. For example, in cases where frame 230 is the current frame and frame 220 is the previous frame, the size of the marked area 221 for frame 220 is different from that of the marked area 231 for frame 230, thus the screen needs to be re-rendered to update the display 150. It is also assumed that the checksum 230A of region 21 in the current frame 230 is CRC3, the checksum 230A of region 22 in the current frame 230 is CRC4, the checksum 220A of region 21 in the previous frame 220 is CRC1 and the checksum 220A of region 22 in the previous frame 220 is CRC2. In such cases, the pixel values associated with region 21 in the current frame 230 are the same as the pixel values associated with the same region 21 in the previous frame 220 (i.e., region 21 remains unchanged in the marked area 221 of frame 220 and the marked area 231 of frame 230) and thus the values of CRC3 and CRC1 will be the same. Similarly, the pixel values associated with region 22 in the current frame 230 are different from the pixel values associated with the same region 22 in the previous frame 220 (i.e., region 22 is changed from being in the unmarked area 222 of frame 220 to being in the marked area 231 of frame 230) and thus the values of CRC4 and CRC2 will be different. As CRC3 is the same as CRC1, region 21 is a non-dirty region for frame 230 and the dirtiness information associated with region 21 in the current frame 230 indicates that the pixels in region 21 are non-dirty. Similarly, as CRC4 is different from CRC2, region 22 is a dirty region for frame 230 and the dirtiness information associated with region 22 of frame 230 indicates that the pixels in region 22 are dirty. By comparing the checksum associated with each region of each of the frames with the checksum associated with a corresponding region of its previous frame as mentioned above, all of the dirty regions, which are regions that have been changed between the frames, for each frame can be determined, as shown in FIG. 2C.

FIG. 2C is a diagram of dirty regions of each frame according to the content update in the frames of FIG. 2B in accordance with the embodiment of the invention. As shown in FIG. 2C, the dirty region of frame 220 is area 223. All regions of frame 220 in the area 223 are referred to as dirty regions. The remaining regions of frame 220 other than the dirty regions are referred to as non-dirty regions. Similarly, the dirty regions of frames 230 and 240 are area 233 and area 243, respectively. It should be understood that the dirty regions of a frame n indicates the difference between frame n and frame (n−1) (e.g., frame n is frame 230 and frame (n−1) is frame 220), and represents the area that the compositor 151 must recompose. It should be noted that, such area may also be known as a surface damage (area) for frame n.

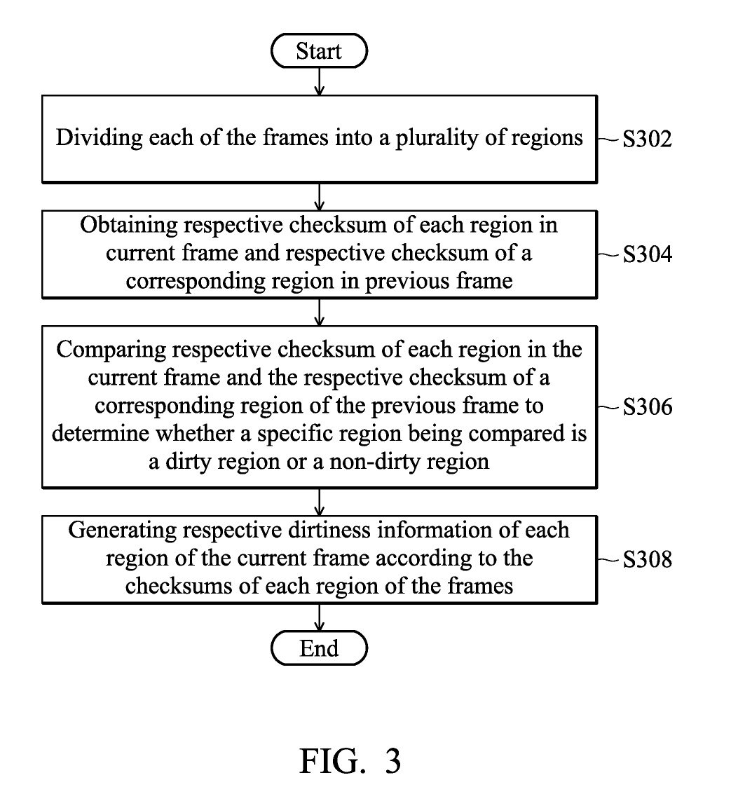

FIG. 3 is a flow chart of a method for generating dirtiness information for image data composed of a plurality of frames in a graphics system in accordance with an embodiment of the invention. In step S302, each of the frames is divided into a plurality of regions. In one embodiment, the regions in each frame can be equally-sized tiles or blocks. In another embodiment, the regions in each frame can be unequally-sized tiles or blocks. In step S304, a respective checksum of each region in a current frame and the respective checksum of a corresponding region in the previous frame are obtained. It should be noted that the respective checksum of each region of the current frame and the respective checksum of a corresponding region of the previous frame can be stored in the same frame buffer where the pixel values of the frames are stored, or it can be stored in another frame buffer, which is different from the frame buffer in which the pixel values of the frames are stored. It should also be noted that in step S306, the respective checksum of each region in the current frame and the respective checksum of a corresponding region in the previous frame are compared to determine whether a specific region being compared is a dirty region or a non-dirty region.

In step S308, the respective dirtiness information of each region of the current frame is generated according to the checksums of each region in the frames. Embodiments in connection to FIGS. 1, 2A-2C and 3 can be referred to for more details about each step, but the application is not limited thereto. Moreover, the steps can be performed in different sequences and/or can be combined or separated in different embodiments.

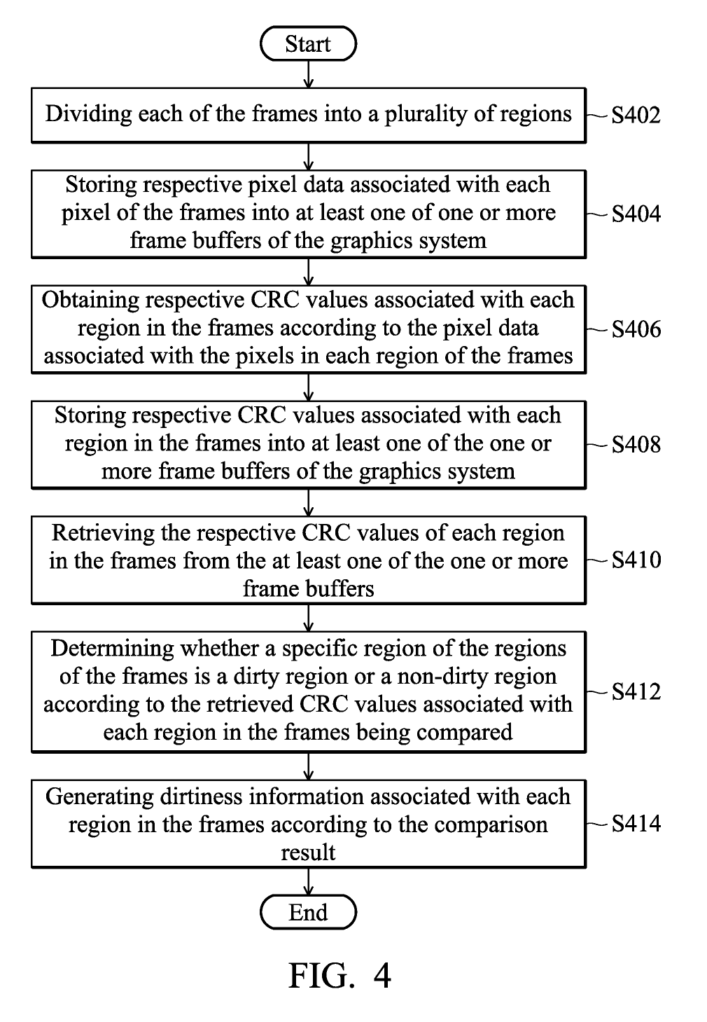

FIG. 4 is a flow chart of a method for generating dirtiness information in a graphics system in accordance with another embodiment of the invention. The graphics system 100 of FIG. 1 is utilized here for explanation of the flow chart, which however, is not limited to only being applied in the graphics system 100. In this embodiment, for the purposes of description, the checksum associated with each region in each frame is a CRC value. One having ordinary skill in the art will appreciate that a different checksum value or code can be used.

In step S402, each of the frames is divided into a plurality of regions, where each region can include a plurality of pixels. Step S402 may be performed by GPU 130 in FIG. 1, for example.

In step S404, respective pixel data associated with each pixel of the frames are stored in at least one of one or more frame buffers in the graphics system 100. It should be noted that the aforementioned pixel data may include the pixel value of the pixel. Step S404 may be performed by GPU 130 in FIG. 1, for example.

In step S406, the respective CRC values associated with each region in the frames are obtained according to the pixel data associated with the pixels in each region of the frames. Step S406 may be performed by GPU 130 in FIG. 1, for example.

In step S408, the respective CRC values associated with each region in the frames are stored into at least one of the one or more frame buffers of the graphics system 100. It should be noted that the respective CRC value associated with each region in each of the frames can be stored into the same frame buffer, or into different frame buffers. Step S408 may be performed by GPU 130 in FIG. 1, for example.

In step S410, the respective CRC value of each region in each of the frames is retrieved from the at least one of the one or more frame buffers. Step S410 may be performed by the dirtiness information generator 132 in FIG. 1, for example.

In step S412, it is determined whether a specific region of the regions in the frames is a dirty region or a non-dirty region according to the retrieved CRC values associated with each region in the frames being compared. Step S412 may be performed by the dirtiness information generator 132 in FIG. 1, for example.

In step S414, dirtiness information associated with each region of the frames is generated according to the comparison result. Step S414 may be performed by the dirtiness information generator 132 in FIG. 1, for example. Specifically, when the CRC value of a specific region in a current frame of the image data is the same as the CRC value of a corresponding region of the previous frame of the image data, the dirtiness information generator 132 generates the dirtiness information indicating that it is a non-dirty region. When the CRC value of a specific region of the current frame of the image data is different from the CRC value of a corresponding region of the previous frame of the image data, the dirtiness information generator 132 generates the dirtiness information indicating that it is a dirty region.

Taking regions 21 and 22 in frame 230 as shown in FIG. 2B as an example, if the CRC values of regions 21 and 22 in frames 220 and 230 are respectively stored in a first frame buffer and a second frame buffer, the dirtiness information generator 132 retrieves the CRC values CRC1 and CRC3 for region 21 and the CRC values CRC2 and CRC4 for region 22 from the first and second frame buffers (step S410), compares CRC3 with CRC1 and compares CRC4 with CRC2 (step S412), and generates dirtiness information associated with regions 21 and 22 according to the respective comparison result (step S414). In this example, as CRC3 is the same as CRC1, the dirtiness information associated with region 21 in frame 230 is a value of 0 to indicate that region 21 is a non-dirty region. Similarly, as CRC4 is different from CRC2, the dirtiness information associated with region 22 in frame 230 is a value of 1 to indicate that region 22 is a dirty region.

After the dirtiness information associated with each region of the frames are generated, the respective dirtiness information associated with each region of the frames may further be stored into the one or more frame buffers of the graphics system 100 and the compositor 151 may retrieve dirtiness information associated with each region of the frames and determine whether to retrieve or skip the pixel data of each region of the frames from the at least one of the one or more frame buffers according to the retrieved dirtiness information associated with each region of the frames. The compositor 151 may then generate a resulting image (e.g., a blended image) according to the retrieved regions of the frames. For example, when the dirtiness information of a specific region indicates a dirty region, the compositor 151 retrieves the data of the specific region from the one or more frame buffers. Conversely, when the dirtiness information of the specific region indicates a non-dirty region, the compositor 151 can skip data access of the specific region from the one or more frame buffers.

In view of the above embodiments, a graphics system and an associated method for generating dirtiness information of data image composed of a plurality of frames are provided. The dirtiness information generator of the graphics system may retrieve the respective checksum of each region of the frames of image data when reading the pixel data of each region of the image from the frame buffer, and provide dirtiness information to indicate which region has been changed or damaged between the frames according to a comparison of the respective checksums of the regions of the frames of image data. For example, when the checksum of a specific region of a current frame of the image data is the same as the checksum of a corresponding region of a previous frame of the image data, the dirtiness information generator generates the dirtiness information indicating that it is a non-dirty region for the specific region. When the checksum of a specific region of the current frame of the image data is different from the checksum of a corresponding region of the previous frame of the image data, the dirtiness information generator generates the dirtiness information indicating that it is a dirty region for the specific region. The compositor can then skip data access of particular regions (i.e., the non-dirty regions) of the frame according to the dirtiness information associated with each region of the frames of image data to avoid wasting time recomposing the regions of the frame that haven't been changed. Accordingly, the dirty regions or damaged regions between the frames can be set appropriately, thus providing efficient partial updating on only the necessary regions between frames and enabling the compositor to recompose only parts of the surface that have changed so as to significantly reduce the number of data accesses to the frame buffer and reduce the required memory bandwidth.

The embodiments of methods for generating dirtiness information indicating dirty regions between frames of image data in a graphics system that have been described, or certain aspects or portions thereof, may be practiced in logic circuits, or may take the form of program code (i.e., instructions) embodied in tangible media, such as floppy diskettes, CD-ROMS, hard drives, or any other machine-readable storage medium, wherein, when the program code is loaded into and executed by a machine such as a smartphone, a mobile phone, or a similar device, the machine becomes an apparatus for practicing the invention. The disclosed methods may also be embodied in the form of program code transmitted over some transmission medium, such as electrical wiring or cabling, through fiber optics, or via any other form of transmission, wherein, when the program code is received and loaded into and executed by a machine, the machine becomes an apparatus for practicing the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for generating dirtiness information indicating dirty regions between frames of image data in a graphics system, comprising:
dividing each of the frames of the image data into a plurality of regions;
obtaining a respective checksum of each region of the frames; and
generating the dirtiness information of each frame of the image data according to the respective checksum of each region of a current frame and a previous frame.

2. The method as claimed in claim 1, wherein the step of generating the dirtiness information of the frames of the image data according to the respective checksum of each region of the current frame and the previous frame comprises:
comparing the checksum of each region of the current frame of the image data with the checksum of a corresponding region of the previous frame of the image data; and
generating the dirtiness information of each region in the current frame of the image data according to the comparison result,
wherein when the checksum of a specific region in the current frame of the image data is the same as the checksum of the specific region in the previous frame, the dirtiness information that indicates a non-dirty region is generated for the specific region, and when the checksum of the specific region in the current frame of the image data is different from the checksum of the specific region of the previous frame, the dirtiness information that indicates a dirty region is generated.

3. The method as claimed in claim 1, wherein the checksum of a specific region in the current frame is related to the pixel data associated with the pixels of the specific region.

4. The method as claimed in claim 3, wherein the checksum is a Cyclic Redundancy Check (CRC) value.

5. The method as claimed in claim 3, wherein the checksum is a hash value.

6. The method as claimed in claim 1, further comprising:
storing the frames into at least one frame buffer of the graphics system; and
storing the respective dirtiness information of each region of the frames into the at least one frame buffer of the graphics system.

7. The method as claimed in claim 6, further comprising:
retrieving the respective dirtiness information of each region of the frames from the at least one frame buffer;
determining whether to retrieve or skip pixel data of each of the regions of the frames from the at least one frame buffer according to the retrieved dirtiness information associated with the region; and
generating a resulting image according to the retrieved regions of the frames.

8. The method as claimed in claim 7, wherein the step of determining whether to retrieve or skip pixel data of each of the regions of the frames from the at least one of one or more respective frame buffers according to the retrieved dirtiness information associated with the region further comprises:
when the dirtiness information of any region of the regions in the frame indicates a non-dirty region, skipping retrieval of the non-dirty region of the frame.

9. The method as claimed in claim 1, wherein the regions are equally-sized tiles or blocks.

10. A graphics system for displaying image data composed of a plurality of frames, comprising:
a graphics processing unit (GPU), configured to divide each of the frames into a plurality of regions; and
a dirtiness information generator, configured to obtain the respective checksum of each region of the frames, and generate the dirtiness information of each frame of the image data according to the respective checksum of each region of a current frame and a previous frame.

11. The graphics system as claimed in claim 10, wherein the dirtiness information generator is configured to compare the checksum of each region of the current frame of the image data with the checksum of a corresponding region of the previous frame of the image data, and generate the dirtiness information of each region of the current frame of the image data according to the comparison result, wherein when the checksum of a specific region in the current frame of the image data is the same as the checksum of the specific region in the previous frame, the dirtiness information generator generates the dirtiness information indicating a non-dirty region for the specific region, and when the checksum of the specific region in the current frame of the image data is different from the checksum of the specific region in the previous frame, the dirtiness information generator generates the dirtiness information indicating a dirty region for the specific region.

12. The graphics system as claimed in claim 11, wherein the checksum of a specific region of the current frame is related to the pixel data associated with the pixels of the specific region.

13. The graphics system as claimed in claim 12, wherein the checksum is a Cyclic Redundancy Check (CRC) value.

14. The graphics system as claimed in claim 12, wherein the checksum is a hash

15. The graphics system as claimed in claim 10, wherein the GPU stores the frames into at least one of one or more frame buffers of the graphics system, and the dirtiness information generator stores the respective dirtiness information of each region of the frames into at least one of the one or more frame buffers of the graphics system.

16. The graphics system as claimed in claim 15, further comprising a compositor for retrieving the respective dirtiness information of each region of the frames from the at least one of the one or more frame buffers, determining whether to retrieve or skip pixel data of each of the regions of the frames from the at least one of the one or more frame buffers according to the retrieved dirtiness information associated with the region and generating a resulting image according to the retrieved regions of the frames.

17. The graphics system as claimed in claim 16, wherein when the dirtiness information of any region of the regions in the frame indicates a non-dirty region, the compositor further skips retrieving of the non-dirty region of the frame.

18. The graphics system as claimed in claim 10, wherein the regions are equally-sized tiles or blocks.

19. The graphics system as claimed in claim 10, wherein the dirtiness information generator is integrated into the GPU.
